(19) United States
(12) Patent Application Publication
(10) Pub. No.: US 2026/0361089 A1
(43) Pub. Date: Nov. 12, 2026

(54) POWER DISTRIBUTION DEVICE

(71) Applicant: NYOBOLT LIMITED, Cambridge (GB)

(72) Inventors: Rebecca Edney, Cambridge (GB); Steve Hutchins, Cambridge (GB); Sai Shivareddy, Cambridge (GB)

(21) Appl. No.: 19/135,492

(22) PCT Filed: Dec. 5, 2023
(86) PCT No.: PCT/EP2023/084344

§ 371 Date: Jun. 4, 2025

(30) Foreign Application Priority Data
Dec. 5, 2022 (GB) 2218243.0

(51) Int. Cl. H02J 3/32; H02J 3/007; H02J 3/17; H02J 3/38; H02J 7/00; H02J 7/04; H02J 7/44; H02J 7/82; H02J 7/90; H02J 101/20; H02J 101/28; H02J 103/35; H02J 105/37

(52) U.S. Cl. CPC H02J 3/322; H02J 3/007; H02J 3/17; H02J 3/381; H02J 7/04; H02J 7/44; H02J 7/825; H02J 7/855; H02J 7/933; H02J 2101/20; H02J 2101/28; H02J 2103/35; H02J 2105/37

(57) ABSTRACT

The invention relates to a device, system and method for distributing power from an electrical power generator to a storage battery and mobile battery. The device comprises a power input for electrically connecting to the power generator, a first power connector for electrically connecting to a storage battery, and a releasable second power connector for electrically connecting to a mobile battery, a power distributor for distributing power from the power input to each of the power connectors, and a controller in communication with the power distributor, wherein the controller is for determining the distribution of power in response to data receivable on the power input from the power generator, and for signalling to the power distributor to provide the determined distribution of power. The invention relates to use of the device for grid scale energy storage and transmission.

### RELATED APPLICATION

The present case claims priority to, and benefit of, GB 2218243.0 filed on 5 Dec. 2022 (5, Dec. 2022), the contents of which are hereby incorporated by reference in their entirety.

### FIELD OF THE INVENTION

The present invention relates to a device, system and method for distributing power from an electrical power generator to a storage battery and mobile battery, to provide grid scale energy storage and transmission. The invention also relates to use of the device for grid scale energy storage.

### BACKGROUND

Currently, in order to reduce the output of greenhouse gasses, there is a drive to increase electrification of infrastructure. For example, the UK government has announced that the sale of new internal combustion cars is to end in 2030 (see references), such cars to be replaced by fully-electric vehicles. This will significantly increase demand on the electrical grid and therefore increase the need for both electrical transmission infrastructure and generation facilities.

The creation of new electrical power stations also introduces problems since these should preferably use renewable energy sources which are not evenly distributed, further increasing the need for improved electrical transmission infrastructure to carry generated electrical power to where it is used.

Furthermore, renewable energy may not be produced on a predictable schedule, leading to waste at times when a surplus of power is generated but it is not used and cannot be transported for storage without significant redundancy in the system, but also shortfalls at times where there is demand but supply is low.

Grid-scale storage batteries exist, for example the Victorian Big Battery system run by Neoen in Geelong, Australia (see references). This system is a large, stationary bank of rechargeable batteries connected to a renewable power source to act as a power reserve and store energy produced at times when the power source is producing above demand. This system relies on the large scale of the storage batteries, which must further be co-located with the power source and are also limited by the capacity of a grid connection. For the same reason, its output is limited by the capacity of its grid connection with no mechanism for any other output of electricity.

U.S. Pat. No. 10,946,762 discloses a system for charging electric vehicles (EVs) comprising vehicles carrying large batteries which are directly charged from a renewable power station. It also discloses control mechanisms which measure supply and demand and control the locations of the mobile batteries. This system is limited to charging of EV batteries and if no EV batteries are available there is no other use for the generated electricity, which will then be wasted. Likewise, it is not capable of dealing with spikes and troughs in supply and demand. The present invention seeks to mitigate the problems with these known systems.

### SUMMARY OF THE INVENTION

At its most general, the present invention provides a device for distributing power from an electrical power generator to grid batteries, including a storage battery and a mobile battery. The storage battery is typically stationary and co-located with the power generator. The storage battery is typically ground mounted and immobile. In other words, the storage battery is not adapted for transport.

In this context, a power generator is a device which transforms power from one type of energy to electricity (e.g., transforms light energy, heat energy or kinetic energy into electricity). In contrast, a grid connection transmits electrical energy. A power generator does not typically include a grid connection.

The mobile battery is typically movable, for example, by being mountable to a transport means, such as an air, land or water based transport means, such as a drone, plane, helicopter, truck, car, train, boat.

The mobile battery may be charged at the electrical generator and then transported from the electrical generator to a second location and discharged at the second location. The discharge at the second location may be to the grid, a second storage battery, or to a second mobile battery (e.g. the battery of an EV). In some embodiments, the mobile battery may be discharged at the second location when during transport (e.g. while the mobile battery is in motion), for example by discharging to an EV during transport.

The invention advantageously allows for power from the electrical power generator to be distributed to a local storage battery. The electrical generator often uses a renewable source which is not always predictable and is not correlated with power demand. Power supply may be high while demand is low, and also power supply may be low while demand is high. The present invention allows for power supply in excess of demand to be stored in a storage battery, which can then be discharged when power demand is in excess of supply.

The invention also provides for distribution of power to a mobile battery, for example when the power supply is greater than can be accepted by the storage battery. The mobile battery is also able to disconnect from the device by its releasable power connection, so it can be transported to another location for discharging. In this way, the mobile battery may transport electrical energy, in part or fully replacing a conventional electrical grid connection. Electrical energy generators, especially renewable energy generators, are often located away from population centres where demand is highest, meaning connection using electrical cables (especially high voltage cables needed for high efficiency energy transmission) is expensive. The provision of mobile batteries allows electrical power to be transported in a flexible manner to where it is required, supplementing or even replacing a conventional grid connection.

In a first aspect of the invention there is provided a device for distributing power from an electrical power generator to batteries, the device comprising:
a power input for electrically connecting to the power generator,
a first power connector for electrically connecting to a storage battery, and a releasable second power connector for electrically connecting to a mobile battery,
a power distributor in electrical communication with the power input and the first and second power connectors, wherein the power distributor is for distributing power from the power input to each of the power connectors, and
a controller in communication with the power distributor, wherein the controller is for determining the distribution of power in response to data receivable on the power input from the power generator, such as the power supplied from the power generator, and for signalling to the power distributor to provide the determined distribution of power.

Typically, the power distributor is for distributing power between each of the power input, the first power connector and the second power connector. In particular, the power distributor is for distributing power from the first power connector and the second power connector.

Typically, the controller is for determining the distribution of power between each of the power input, the first power connector and the second power connector. That is, the controller is for determining the distribution of power between the first power connector and the second power connector. In this way, the device may control the distribution of power from the power generator to the batteries, and also the distribution of power from the storage battery to the mobile battery.

In some embodiments, the device further comprises:
a power output for electrically connecting to an electricity grid,
wherein the power distributor is in electrical communication with the power output, and the power distributor is for distributing power from the power input to each of the power connectors and the power output,
wherein the controller is for determining the distribution of power in response to data receivable on the power output to the electricity grid, such as the power demand of the electricity grid.

In some embodiments, the device further comprises a demand determination engine in communication with the controller and the power output, wherein the demand determination engine is for determining the power demand of the electricity grid and for sending data on the power demand to the controller.

In some embodiments, the power distributor is for distributing power from the storage battery to the electricity grid through the power output.

In some embodiments, the power distributor comprises a switch, for switching electrical distribution between the power connectors and the power output.

In some embodiments, the switch comprises a first switch and a second switch, wherein the first switch is switchable for electrical distribution between the power output to the grid and the second switch, and
the second switch is switchable for electrical distribution between the first power connector to the storage battery and the releasable second power connector to the mobile battery.

In some embodiments, the controller is for determining the distribution of power in response to data receivable on the storage battery and/or the mobile battery, such as data on the state of charge, maximum operable charge rate, and temperature, and preferably data on the state of charge.

In some embodiments, the device further comprises a state of charge determination engine in communication with the controller and one or more of the power connectors, wherein the state of charge determination engine is for determining the state of charge of the storage battery and/or the mobile battery and for sending data on the state of charge to the controller. In some embodiments, the power input is for receiving 100 kW or more from the power generator, such as 500 kW or more, or 1,000 kW or more.

In some embodiments, the electrical power generator is a renewable energy electrical power generator, such as a renewable energy based electrical power generator using solar, wind, wave, hydro, tidal, or geothermal energy.

In a second aspect of the invention there is provided a system for distributing power from an electrical power generator to batteries, the system comprising
the device of the first aspect,
a storage battery electrically connected to the first power connector, and
a mobile battery releasably electrically connected to the releasable second power connector.

In some embodiments of the system,
(i) the total discharge capacity of the mobile battery is less than the total discharge capacity of storage battery, preferably the total discharge capacity of the mobile battery is 50% or less than the total discharge capacity of storage battery, more preferably 25% or less, even more preferably 10% or less; and/or
(ii) the maximum operable charge rate of the mobile battery is more than the maximum operable charge rate of the storage battery.

In some embodiments, the total discharge capacity of the storage battery is 10 kAh or more, such as 50 kAh or more, or 100 kAh or more. In some embodiments, the total energy storage capacity of the storage battery is 10 kWh or more, such as 500 kWh or more, or 1000 kWh or more.

In some embodiments, the total discharge capacity of the mobile battery is 3 kAh or more, such as 10 kAh or more, or 20 kAh or more. In some embodiments, the total energy storage capacity of the storage battery is 10 kWh or more, such as 50 kWh or more, or 100 kWh or more, or 200 kWh or more.

In some embodiments, the controller is in communication with the mobile battery and the controller is for signalling to the mobile battery to disconnect from or connect to the releasable second power connector in response to data on the mobile battery, such as data on the state of charge of the mobile battery.

In some embodiments, the controller is in communication with the mobile battery and the controller is for signalling to the mobile battery to disconnect from or connect to a releasable third power connector at a different location to the power generator, wherein the third power connector is in electrical communication with an electricity grid or a third storage battery, preferably wherein the third storage battery is provided in a mobile electronic device.

In some embodiments, the system includes two or more mobile batteries, releasably electrically connected to the releasable second power connector.

In a third aspect of the invention there is provided a method for controlling power distribution from a power generator to batteries, using a system comprising:
a power input electrically connected to the power generator,
a first power connector electrically connecting to a storage battery, and a releasable second power connector electrically connecting to a mobile battery,
a power distributor in electrical communication with the power input and the power connectors, wherein the power distributor is for distribution of power between each of the power input and the power connectors, and
a controller in communication with the power distributor, the method comprising the steps of:
determining the power input of the power generator and sending data on the power input to the controller,
the controller determining a distribution of power in response to the power input data, and
signalling from the controller to the power distributor to provide the determined distribution of power.

In some embodiments the system further comprises a power output electrically connecting to an electricity grid, wherein the power distributor is in electrical communication with the power output, and the power distributor is for distributing power from the power input to each of the power connectors and the power output, and for distributing power from the first power connector to the power output,

the method further comprising the steps of:
determining the power demand of the electricity grid and sending data on the power demand to the controller, and
the controller determining a distribution of power in response to power input data and power demand data.

In some embodiments determining the distribution of power comprises comparing data on the power input from the power generator against data on the power demand of the electricity grid, and
when the power input is less than the power demand the controller distributes the power input to the electricity grid, or
when the power input is more than the power demand the controller distributes the power input to the storage battery and/or the mobile battery, and optionally to the electricity grid.

In some embodiments when the power input is more than the power demand the controller distributes the difference between the power input and the power demand to the storage battery and/or the mobile battery.

In some embodiments, when the power input is less than the power demand the controller distributes power from the storage battery to the electricity grid.

In some embodiments the controller is in communication with the storage battery and/or the mobile battery, and the method comprises:
determining data on the storage battery and/or the mobile battery, and sending data on the storage battery and/or the mobile battery to the controller, such as data on the maximum charging power and/or state of charge of the storage battery and/or the mobile battery,
the controller determining a distribution of power in response to the data on the storage battery and/or the mobile battery.

In some embodiments determining the distribution of power comprises comparing the power input data to data on the maximum charging power of the storage battery, and
when the power input is less than the maximum charging power of the storage battery the controller distributes the power input to the storage battery, or when the power input is more than the maximum charging power of the storage battery the controller distributes the power input to the storage battery and the mobile battery.

In some embodiments when the power input is more than the maximum charging power of the storage battery, the controller distributes the difference in power between the power input and the maximum charging power of the storage battery to the mobile battery.

In some embodiments determining the distribution of power comprises comparing data on the state of charge of the storage battery against a maximum state of charge value, and
when the state of charge of the storage battery is less than the maximum state of charge value, the controller distributes power from the power input to the storage battery, or
when the state of charge of the storage battery is the maximum state of charge value or more, the controller distributes power from the power input to the mobile battery.
wherein the maximum state of charge value is 80%, preferably 90%, more preferably 95%.

In some embodiments the controller is in communication with the mobile battery and the controller signals to the mobile battery to disconnect from or connect to a releasable third power connector at a different location to the power generator, wherein the third power connector is in electrical communication with an electricity grid or a third storage battery, and the mobile battery transfers power to the third power connector.

Preferably, the third power connector is not in electrical communication with the power generator. In general, the third power connector is an input to the electricity grid closer to power demand than the power generator. In this way, the mobile battery can be used to transport power to the grid near to the power demand, rather than relying on traditional cable power transmission direct from the power generator.

A different location to the power generator typically refers to a location which is 10 km or more away from the power generator, such as 50 km or more, 100 km or more, 200 km or more.

In some embodiments the third power connector is on a mobile electronic device, and the mobile battery transfers power to the releasable third power connector while the mobile electronic device is in motion. In one such embodiment, the mobile electronic device is an electric vehicle.

In a fourth aspect of the invention there is provided a use of a device of the first aspect for distributing power from an electrical power generator to a storage battery and/or a mobile battery, for grid scale energy storage.

### SUMMARY OF THE FIGURES

The present invention is described with reference to the figures listed below.

FIGS. 1A and 1B show a high-level overview of an embodiment of the system.

FIG. 2 shows an example block diagram of an embodiment of the system.

FIGS. 3A and 3B show two example embodiments of the switch.

FIG. 4 shows an example decision tree algorithm followed by the controller.

FIG. 5 shows a second example decision tree algorithm followed by the controller.

### DETAILED DESCRIPTION OF THE INVENTION

The present invention provides a device for distributing power from an electrical power generator to grid batteries, including a storage battery and a mobile battery.

In a first aspect of the invention there is provided a device for distributing power from an electrical power generator to batteries, the device comprising:
a power input for electrically connecting to the power generator,
a first power connector for electrically connecting to a storage battery, and a releasable second power connector for electrically connecting to a mobile battery,
a power distributor in electrical communication with the power input and the first and second power connectors, wherein the power distributor is for distributing power from the power input to each of the power connectors, and
a controller in communication with the power distributor, wherein the controller is for determining the distribution of power in response to data receivable on the power input from the power generator, such as the power supplied from the power generator, and for signalling to the power distributor to provide the determined distribution of power.

In a second aspect of the invention there is provided a system for distributing power from an electrical power generator to batteries, the system comprising
the device of the first aspect,
a storage battery electrically connected to the first power connector, and
a mobile battery releasably electrically connected to the releasable second power connector.

The invention advantageously allows for power from the electrical power generator to be both stored locally in the large storage battery (e.g. to store power surges when power demand is low) and to be transported to locations where the power is needed using the mobile batteries (e.g. to transport power which cannot be handled by a standard grid connection at the electrical generator site).

Some storage battery systems are known.

The Victorian Big Battery is different to the present invention because it is only designed as a backup system. Big Battery is less intelligent and is limited to the scale of the storage batteries, which must further be co-located with the power source and are also limited by the capacity of a grid connection. The present invention includes mobile batteries and a controller to switch power between the mobile and storage batteries.

U.S. Pat. No. 10,946,762 differs from the present invention because it does not include a stationary storage battery and involves no switching between power destinations. The document does not disclose a switching control mechanism. UU.S. Pat. No. 10,946,762 is specifically designed for charging an EV at a second location different to the first location where the power source is located.

In addition, US 2020/0231057 describes a system including a power transfer unit, connected to a power generator, a stationary battery and mobile batteries located in electric vehicles (EVs), as well as a control unit to control the power transfer between the power generator, storage battery, and mobile batteries. The system uses the EV batteries as a buffer to receive energy from power generator and deliver energy to the grid. The system of US 2020/0231057 differs from the present invention where a static storage battery is used as a buffer to receiver excess power from the power generator. The storage battery provides this excess energy to the mobile batteries and/or grid to transport the electrical energy.

The system described in US 2020/0231057 charges and discharges the stationary battery and mobile batteries at the same location. In contrast, in preferred embodiments of the present invention the stationary battery is co-located with the power generator, and the mobile batteries are charged and discharged at different locations to transport the electrical energy.

EP 4002633 describes a power feeding system, which distributes power from a power generator to a battery and a power supply. The system sends surplus power to a static battery, such that the battery provides power when the generator is off or cannot meet demand. EP 4002633 does not describe the combination of a storage battery and a mobile battery. The batteries in EP 4002633 are not mobile batteries. The mobile batteries in the present invention are preferably used to transport electrical energy. EP 4002633 does not describe that power is transferred between the batteries. In the present invention, the storage battery may transfer energy to the mobile batteries.

GB 2554343 describes a transportable energy storage system. The system includes a mobile battery, which moves between a charging station and a discharging station. The document does not describe a system including a storage battery and a mobile battery in combination, or that power may be distributed between a storage battery and a mobile battery. GB 2554343 relates to the use of lithium titanate batteries as mobile batteries, which differs from the preferred niobium-based battery chemistry described in the present invention. EP 4071958 describes a system where energy from a power generator is transferred to the batteries of EVs, and the EVs transport power to a local electricity grid. EP 4071958 teaches against the use of stationary storage batteries, and that using mobile batteries removes the need for a large-capacity storage battery. This differs from the present invention which describes the combination of a storage battery and a mobile battery.

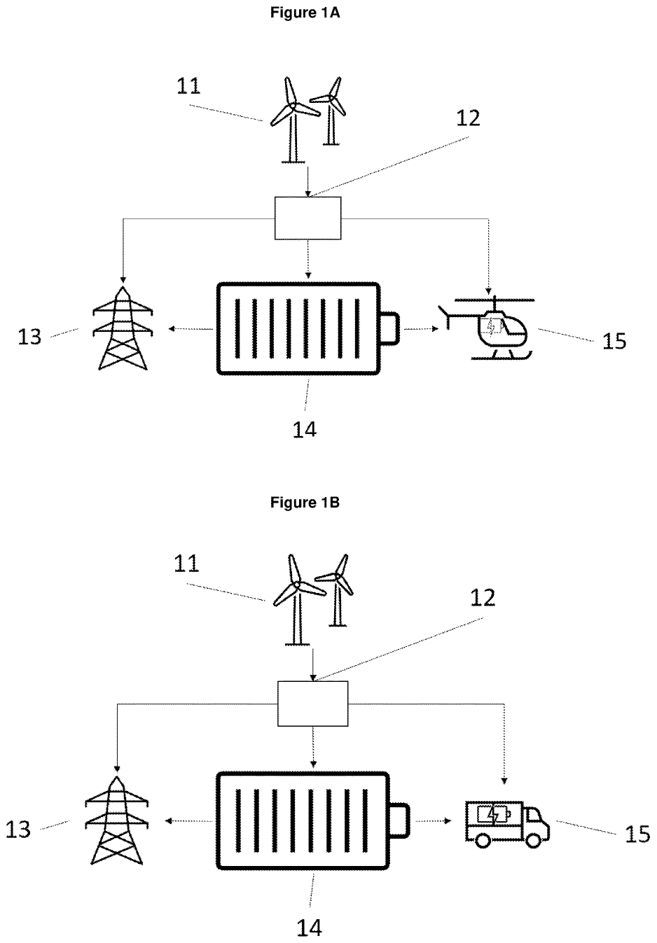

GB 2537944 describes a storage-based charging system, which receives power from the grid, and distributes the power to a storage battery and an EV battery (see FIG. 1). Both the storage battery and the EV batteries are serving as “mobile” batteries. This differs from preferred embodiments of the present invention where the storage battery is stationary and co-located with a power generator. Additionally, the EV batteries described in GB 2537944 are intended to charge and discharge power at the same location. The mobile battery of the present invention is for transporting electrical energy, by charging and discharging at different locations. Moreover, GB 2537944 relates to the use of lithium titanate batteries, which differs from the preferred niobium-based battery chemistry described in the present invention.

In some embodiments, the invention relates to a system and method for maximizing the efficient use of a renewable energy system, comprising:
an electrical generator;
power destinations including:
   a connection to an electrical grid;
   a large storage battery;
   one or more small mobile batteries;
a power distribution device which carries out a control method for switching between the grid, the storage battery, and the mobile batteries.

The invention also relates to a control method carried out by the controller, which uses signals from the power destinations to direct generated power appropriately as well as carrying out balancing between the power destinations.

In some embodiments, the storage battery is for buffering electrical energy from the power generator.

In some embodiments, the mobile battery is for transporting electrical energy. In some embodiments, the mobile battery is charged and discharged at different locations. For example, the mobile battery is charged at the power generator and discharged at a location different from the power generator. That is, the releasable second power connector for charging the mobile battery is co-located with the power generator. The mobile battery is discharged at a different location to the power generator.

In some embodiments, the storage battery and the mobile battery differ in at least one aspect. The different aspects may include different electrical properties, chemical properties, physical properties, structural properties or electrochemical properties. The different aspects may be one or more selected from the list consisting of electrical properties, chemical properties, physical properties, structural properties and electrochemical properties. Preferably the mobile battery and storage battery have different electrochemical properties.

For example, two batteries may be different because they have different electrical properties, such as a different voltage profile. Two batteries may be different because they have different chemical properties, such as a different anode active material. Two batteries may be different because they have different structural properties, such as a different anode structure. Two batteries may be different because they have different physical properties, such as the degree of degradation from previous cell cycling.

Different electrical properties include different cell cycling properties. In some cases, the discharge and/or charge voltammogram are different, the nominal discharge and/or charge voltage (e.g. nominal voltage) are different, the cell voltage at 100% state of charge (SOC) is different, and/or the voltage profiles during discharging and/or charging are different.

Preferably the nominal voltage is different, the cell voltage at 100% SOC is different and/or the voltage profiles during discharging and/or charging are different. More preferably the cell voltage at 100% SOC is different and/or the voltage profiles during discharging and/or charging are different. Most preferably the voltage profiles during discharging and/or charging are different.

Different chemical properties include different cell chemistries. Two or the batteries may be different if they have different cell chemistries. Different cell chemistry typically refers to at least one different electrode material, such as a different anode and/or different cathode material, or a different charge carrier. Preferably, different battery chemistry refers to different working electrode active material, such as cathode active material or anode active material. Preferably the anode active material is different. Different chemistry leads to the batteries being able to provide for different current draws, which in turn means that they require different power converters to provide a steady output.

Different structural properties include different cell morphology or structure. Two of the batteries may be different if they have different cell morphology. Different cell morphology may refer to the internal morphology of the electrode, such as particle size of electrode material, particle size distribution of electrode material, coating thickness (of films or particles), hierarchical or non-hierarchical structures in the electrode, porosity of the electrode, specific surface area of the electrode.

Preferably, the storage battery has a larger capacity than the mobile battery.

In some embodiments, the storage battery is for buffering electrical energy from the power generator.

In some embodiments the system comprises two or more mobile batteries, such as 5 or more mobile batteries, such as 10 or more mobile batteries, such as 20 or more mobile batteries.

The multiple mobile batteries are typically not connected to the device simultaneously. The mobile batteries may shuttle between a second power connector (e.g., when connected to the device) and a discharging connector at a different location. In this way, the mobile batteries may be for transporting electrical energy by shuttling between a charging connector (the second power connector) and a discharging connector at a different location.

In some embodiments, the device comprises two or more releasable second power connectors, such as 5 or more releasable second power connectors, such as 10 or more releasable second power connectors, such as 20 or more releasable second power connectors. Preferably, the system comprises fewer releasable second power connectors than mobile batteries. The mobile batteries may be distributed between the second power connectors, a discharging connector, and a location between the second power connector and the discharging connector.

In some embodiments, the storage battery can transfer energy to the mobile batteries. In some embodiments, the power distributor is for distributing power from the first power connector to the second power connector. In such embodiments, the controller is for determining the distribution of power from the first power connector to the second power connector. In this way, the device may control the distribution of power from the power generator to the batteries, and also the distribution of power from the storage battery to the mobile battery.

Preferably, the electrical generator uses a renewable source of energy such as the sun, wind, waves, hydropower, tidal, or geothermal energy. Such sources of energy are not always predictable—for example, a photovoltaic system which uses the sun as an energy source will generate less power in poor weather—and therefore will benefit from battery storage systems. Furthermore, under some circumstances they may generate electrical power in excess of demand—for example, a tidal power station is reliant on the tides, which may go in and out during the night when demand is low—and such power may be wasted without a storage mechanism.

The system of the invention provides a further benefit for a renewable energy system because many such systems are located at a distance from centres of demand. For example, it is beneficial to locate a wind farm at sea or in mountainous areas where there is plenty of wind and significant empty space. Naturally, such areas are often sparsely populated and it is necessary to route generated electrical power a significant distance to population centres where it can be used. This necessity creates a bottleneck that further increases the chance of waste. Furthermore, conventional grid connections require electrical cables to be installed to all locations where electrical power may be required, including those that are extremely remote. The provision of mobile batteries allows electrical power to be transported in a flexible manner to where it is required, supplementing or even replacing a conventional grid connection.

Preferably, the storage battery and mobile batteries are capable of rapid charging, including rapid charging from one battery to another through a system such as that disclosed in WO 2019/234248 or WO 2021/074406, the contents of which are incorporated herein by reference. This is beneficial because it will maximise the flexibility of the system and increase its utility during power surges. Rapid-charging and -discharging batteries will also be better able to account for rapid and short-term dips and spikes in both demand and supply, which are common in all systems. This will allow the system to smooth the power supplied to the grid.

FIGS. 1A and 1B shows a high-level overview of an example embodiment of the system. This embodiment includes three possible power destinations: a connection to an electrical grid [13], a large storage battery [14], and a collection of mobile batteries [15], one of which is shown in the Figure. The mobile battery [15] shown in the FIG. 1A is a flying vehicle comprising a single battery. The mobile battery [15] shown in FIG. 1B is a ground-based vehicle comprising a single battery. The vehicle could also be a ground-based (for example, fitted with wheels or tracks or running on rails) or water-borne vehicle depending on the most appropriate method of transportation for the context. A mobile battery [15] comprising a single battery, such as that shown in FIGS. 1A and 1B, could be used to supply the grid from a connection located at a destination location, charge a storage battery at a destination or directly charge recipient devices such as vehicles or tools. In this case the recipient device could be in motion during charging.

The mobile battery [15] could instead be modular, with multiple smaller batteries that could be removed and, for example, inserted into recipient devices such as vehicles, tools, or static equipment at the mobile battery's [15] destination.

The power source [11] (also referred to as an electrical power generator) shown in FIGS. 1A and 1B is a wind farm, but, naturally, it could be any appropriate power source, most preferably a renewable power station such as a solar farm, hydroelectric dam, etc.

In this embodiment, the power source [11] and the power destinations [13, 14, 15] (also referred to as power connectors) are all connected to a direction block [12] which receives electrical power from the power source [11] and directs it to the power destinations [13, 14, 15] in accordance with internal stored priority instructions and the statuses of the power destinations [13, 14, 15]. Accordingly, the power source [11] and power destinations [13, 14, 15] also have signalling connections to the direction block [12], though for clarity these are not shown separately in FIG. 1.

The storage battery [14] is also connected to the grid [13] and the mobile battery [15] to allow it to discharge power to them when required.

Preferably, one or both of the storage battery [14] and the mobile batteries [15] are made up of cells that comprise a working electrode active material comprising a metal oxide. Preferably, the working electrode is the anode during a discharge step.

In some embodiments the metal oxide is a niobium oxide or niobium metal oxide. The metal oxide comprising the working electrode active material is preferably a niobium-based material, such as niobium oxide, or a niobium metal oxide such as niobium nickel oxide, niobium tungsten oxide, niobium titanium oxide, niobium molybdenum oxide, niobium aluminium oxide, niobium gallium oxide, niobium germanium oxide, niobium copper oxide, or niobium zinc oxide for example, as described in WO 2019/234248, the content of which is incorporated herein by reference in its entirety.

In some embodiments the working electrode active material may comprise Nb₂O_{5,} Nb₂NiO₆, Nb₁₂WO₃₃, Nb₂₆W₄₀₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb& W₉O₄₇, Nb₅₄W₈₂O₃₈₁, Nb₂₀W₃₁O₁₄₃, Nb₄W₇O₃₁, Nb₂W₁₅O₅₀, Nb₂WO₈, Nb₂TiO₇, Nb₁₀Ti₂O₂₉, Nb₂₄TiO₆₂, Nb₂M₀₃O₁₄, Nb₁₄MO₃O₄₄, Nb₁₂MOO₄₄, Nb₁₁AIO₂₉, Nb₁₁GaO₂₉ Nb₄₉GaO₁₂₄, Nb₁₈GeO₄₇, Nb₃₄CU₂O₈₇, or Nb₃₄Zn₂O₈.

This material has favourable lithium ion diffusion properties and thus exhibits superior performance even where micron-sized particles of the niobium-based material are used.

Accordingly, a working electrode comprising a niobium-based material, such as niobium oxide or a niobium metal oxide, exhibits extremely high volumetric energy density and high capacity at high rates of charging and discharging, which provides for a higher C-rate.

The term “C-rate” has its common meaning as known in the art, referring to a normalized charge or discharge rate obtained by dividing the total discharge capacity of the cell (Ah) by a total period of time of 1 hour (h). A C-rate may be denoted in terms of “3 C”, to mean a C-rate of 3.

Alternatively, the metal oxide comprising the working electrode active material may comprise another metal oxide such as lithium titanium oxide, titanium dioxide, silicon oxide, or vanadium oxide. These metal oxides typically display similar electrochemical properties to the niobium oxide or niobium metal oxide.

Alternatively, the working electrode may be entirely comprised of another suitable active material such as carbon or graphite.

The working electrode may be comprised of a combination of a metal oxide with another suitable active material such as carbon, graphite, and other metal oxides.

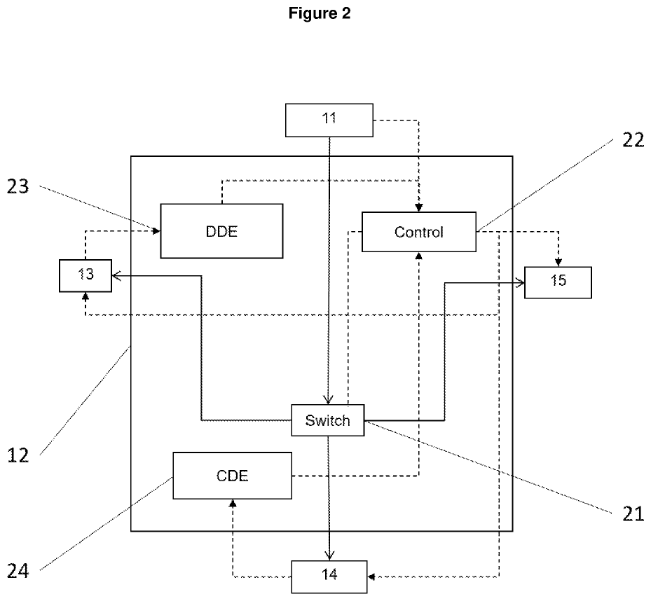

FIG. 2 shows an example block diagram of an embodiment of the direction block [12] (also referred to as a device for distributing power). The power supply [11] and the grid [13], storage battery [14], and mobile battery [15] are shown connected to the direction block [12], together with their signalling connections. In FIG. 2, signalling connections are shown with dashed arrows and power connections are shown with solid arrows.

The direction block [12] comprises a demand determination engine (DDE) [23] which determines the level of demand from the grid [13]; a state of charge (SoC) determination engine (CDE) [24] which determines the current SoC of the storage battery [14], a switch [21] which determines which of the power destinations [13, 14, 15] is currently receiving electrical power from the power source [11], a main controller [22] which receives signals from other engines [23, 24] and controls the switch [21]. The switch may be more generally known as a power distributor.

The DDE [23] receives signals from a controller [22] on the connection to the grid [13] (the grid controller), which is not shown here but is arranged to determine the current demand being made by users on the grid [13]. Either the grid controller or the DDE [23] may determine whether the current demand is above or below the current supply. It then transmits data on the demand to the main controller [22]. This data may take the form of a simple indication that the supply to the grid [13] should be raised, lowered, or maintained or it may comprise actual demand data.

The CDE [24] receives signals from a controller incorporated into the storage battery [14], for example as part of the battery management system (BMS), which indicate the current SoC of the battery [14]. The CDE [24] can then use this information to determine whether the battery [14] is fully charged and whether it will be able to safely receive further charge if there is more power available. Again, it can then transmit this information to the main controller [22].

The controller [22] receives information from the DDE [23] and CDE [24] and determines the optimal behaviour of the switch [21]. It then transmits signals to the switch [21] to command it to change the destination of power.

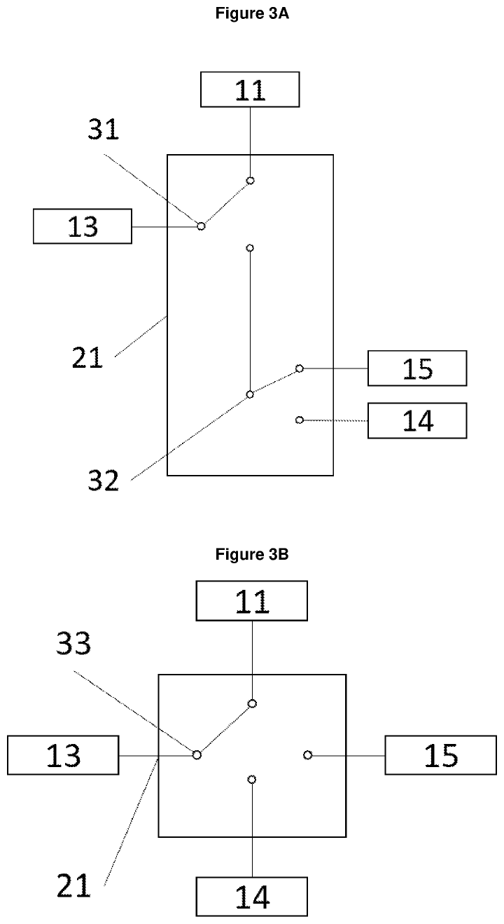

FIGS. 3a and 3b show example embodiments of the switch [21]. The description of the switch herein also applies to a power distributor.

FIG. 3a shows an embodiment which prioritises the connection to the grid [13], with two internal switches [31, 32] the first of which [31] selects between a connection to the grid [13] and a connection to the second switch [32], which in turn selects between the storage battery [14] and the mobile battery [15]. These switches [31, 32] may be controlled independently meaning that, for example, the second switch [32] may maintain a connection to the storage battery while the first switch [31] is controlled to turn the connection to the grid [13] on and off depending on demand, meaning that power is supplied to the grid [13] except when supply exceeds demand, when the first switch [31] may be connected to the batteries [14, 15].

FIG. 3b shows an alternative embodiment with a single three-way switch [33], allowing the power supply to be switched between all three destinations [14, 15, 16] in accordance with instructions from the main controller.

Both of these embodiments of the switch [21] may be arranged such that the switch [21] constantly switches between connection to the batteries [14, 15] and connection to the grid [13], with the duty cycle of the switch [21] being determined by the main controller [22] based on demand information received from the DDE. For example, when the demand is high the switch [21] may spend 75% of the time connected to the connection to the grid [13] but when the demand is low the main controller [22] may signal the switch [21] to spend only 25% of the time connected to the connection to the grid [13] and the remaining time connected to one of the batteries [14, 15]. A continuous power distributor may also be used in place of a switch, for example, which continuously splits and distributes the power to the different batteries and the grid. The net distribution of power using the continuous power distributor is the same as described above for the switch.

FIG. 2 further shows direct signalling connections from the main controller [22] to the grid [13], the storage battery [14], and the mobile battery [15]. These allow the main controller [22] to signal the storage battery [14] to supply power to the grid [13] or to the mobile batteries [15], as shown in FIG. 1, and also to instruct the grid [13] and the mobile battery [15] to receive power from the storage battery [14]. Such a signalling connection to the mobile battery [15] could also be used to control the mobile batteries [15] themselves, for example directing a battery [15] that is at a maximum SoC to go to a specified location and/or summoning a new battery [15] to charge.

The main controller [22] can use algorithms based on prioritisation and demand to determine what signalling it sends to the switch [21]. For example, using the example switch [21] shown in FIGS. 3a or 3b. The main controller can use machine learning algorithms or heuristic algorithms to interpret past data on prioritisation and demand, and determine the signalling the controller sends to the switch.

Accordingly in a third aspect of the invention there is provided a method for controlling power distribution from a power generator to batteries, using a system comprising:
a power input electrically connected to the power generator,
a first power connector electrically connecting to a storage battery, and a releasable second power connector electrically connecting to a mobile battery,
a power distributor in electrical communication with the power input and the power connectors, wherein the power distributor is for distribution of power between each of the power input and the power connectors, and
a controller in communication with the power distributor, the method comprising the steps of:
determining the power input of the power generator and sending data on the power input to the controller,
the controller determining a distribution of power in response to the power input data, and
signalling from the controller to the power distributor to provide the determined distribution of power.

In some embodiments, the main controller [22] is arranged to prioritise supply to the grid [13] first and then to prioritise supply to the storage battery [14]. In this case, the second switch switch [32] remains connected to the storage battery [14] until the main controller [22] receives a signal from the CDE [24] indicating that the storage battery [14] has reached a maximum SoC. The first switch [31] moves between connection to the grid [13] and connection to the second switch [32] with a duty cycle depending on the demand as previously described.

In other embodiments, the main controller [22] is arranged to prioritise supply to the storage battery [14] and use the storage battery [14] to supply the grid [13]. This could be used to ensure a consistent supply to the grid [13] at a constant level. In this case, the first switch [31] could remain connected to the second switch [32] and the second switch [32] could remain connected to the storage battery [14] except where the main controller [22] receives a signal from the CDE [24] indicating that the storage battery [14] has reached a maximum SoC, in which case the second switch [32] could be changed to connect to the mobile battery [15] until the CDE [24] indicates that the SoC of the storage battery [14] has fallen below a threshold. Additionally, if the SoC of the storage battery [14] falls below a minimum level the main controller [22] could change the first switch [31] to connect the power source [11] directly to the grid [13] as required based on the demand as indicated by the DDE [23].

The main controller [22] may be arranged to prioritise supply to the grid [13] first and then to prioritise supply to the mobile battery [15]. This would operate in much the same way as the first example above except that the second switch [32] would be connected to the mobile battery [15] except where there is no empty mobile battery [15] available, in which case the main controller [22] could change the second switch [32] to be connected to the storage battery [14]. In this case the main controller [22] could also signal the storage battery [14] to charge the mobile battery [15] when an empty mobile battery [15] becomes available.

These are example algorithms only and do not limit the interpretation of the claims.

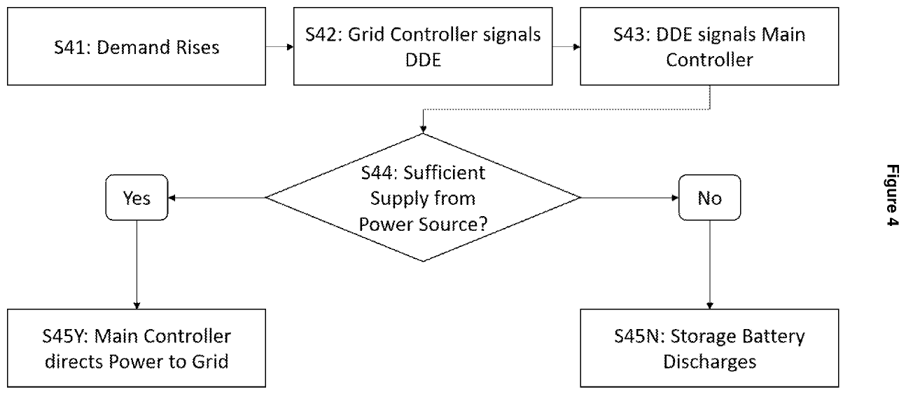

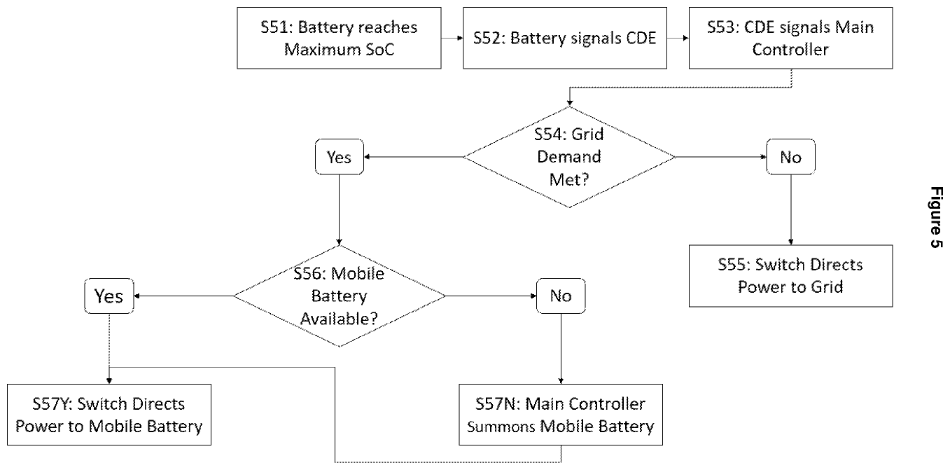

FIGS. 4 and 5 show example processes that the system could follow in different circumstances. The first example is based on the assumption that the main controller [22] is operating based on an algorithm that prioritises directing power received from the power source [11] to the grid [13] first depending on demand, then to the storage battery [14], and then to the mobile battery [15]. The second example is based on the assumption that the main controller [22] is operating based on an algorithm that prioritises directing power received from the power source [11] to the storage battery [14] first, then to the grid [13] depending on demand, and then to the mobile battery [15]. Both processes are also based on the assumption that the switch [21] in the system is similar to the one shown in FIG. 3b.

Beginning with FIG. 4, at Step S41, the demand for electricity on the grid [13] rises. This may be due to increased user demand; for example, it is a known phenomenon that there is a spike in demand for electricity in the evening when people return home from work.

At Step S42, the grid controller detects the increase in demand and transmits a signal to the DDE [23] in the direction block indicating the level of increase.

At Step S43, the DDE [23] signals the main controller [22] requesting an increase in the power supplied to the grid [13].

At Step S44, the main controller [22] determines whether sufficient electrical power is being supplied by the power source [11]. This may be based on signalling from a controller on the power source [11] or on detection of the incoming supply. If the main controller [22] determines that there is sufficient supply available, the process follows the branch to the left beginning at “Yes”. Otherwise it follows the branch to the right beginning at “No”.

At Step S45Y, the main controller [22] increases the supply of electrical power to the grid [13]. This may involve changing the duty cycle of the switch [21] so that, for example, it goes from being connected to the grid [13] 50% of the time and the storage battery [14] 50% of the time to being connected to the grid [13] 75% of the time and the storage battery [14] 25% of the time.

At Step S45N, the main controller [22] signals a controller associated with the storage battery [14] and instructs it to discharge the storage battery to supply the grid [13], maintaining a sufficient supply to meet the increased demand.

FIG. 5 shows the process followed in a different system, as previously described, and a different scenario.

At Step S51, the storage battery [14] reaches its maximum SoC. This may be because, for example, the supply of electrical power from the power supply [11] significantly exceeds the demand for power from the grid [13].

At Step S52, the battery controller transmits a signal to the CDE [24] to indicate that the storage battery [14] has reached its maximum safe SoC and, in turn, at Step S53 the CDE [24] signals the main controller [22].

At Step S54, the main controller [22] determines whether the grid demand is currently being met, since in a situation where the main controller [22] prioritises the storage battery [14] and the storage battery [14] then supplies the grid [13], the storage battery [14] may be filling up because it is not supplying enough power to the grid [13]. The main controller [22] may determine this based on signals from the DDE [23], whether by polling the DDE [23] to check the current demand or determining that there has been no recent signal from the DDE [23] indicating that the demand has risen.

If the grid demand is not being met, the process follows the branch to the right to Step S55 and the main controller [22] directs more power to the grid [13], whether directly by changing the behaviour of the switch [21] so it connects to the grid [13] with a longer duty cycle or at all, or by transmitting a signal to the battery controller indicating that it should discharge more power to the grid [13].

If the grid demand is being met, there is surplus power available and the process follows the branch to the left, beginning at “Yes”.

At Step S56, the main controller [22] determines whether there is a mobile battery [15] currently available, connected to the system for charging, and not already at a maximum SoC. If so, the process follows the branch to the left beginning at “Yes”, to Step S57Y. If not, the process follows the branch to the right beginning at “No”, to Step S57N.

At Step S57N the main controller [22] sends a signal to a mobile battery controller to summon a mobile battery [15]. This may comprise a wireless signal to a mobile battery [15] or a signal to a storage location which causes a controller to dispatch a mobile battery [15]. In any case, a mobile battery [15] travels to a docking location with a charger and connects to it or is connected as appropriate.

The process then moves to Step S57Y and proceeds as if the mobile battery [15] had already been connected at Step S56.

Returning to the branch beginning at “Yes”, at Step S57Y the main controller [15] changes the configuration of the switch [21] to direct power to the mobile battery [15] instead of the storage battery [14], preferably in the same proportions. This may continue until the connected mobile battery [15] reaches a maximum state of charge or until there is another change of circumstances such as a change in demand from the grid [13].

Optionally, increases in demand from the grid [13] could be served by discharging the storage battery [14], especially if such increases are of short duration. This would limit the changes required to the settings and could also allow for instant or near-instant responses to short-term spikes in demand without the overhead of changing the switch [21]. In this case, power could be redirected back to the storage battery [14] when it falls below a threshold SoC, but power could also be redirected during the period between one mobile battery [15] reaching a maximum SoC and a new one being summoned, avoiding waste.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure. “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### REFERENCES

A number of publications are cited above in order to more fully describe and disclose the invention and the state of the art to which the invention pertains. Full citations for these references are provided below. The entirety of each of these references is incorporated herein.

UK Government, Low emission electric vehicles, “Government takes historic step towards net-zero with end of sale of new petrol and diesel cars by 2030” press release published 18 Nov. 2020
www.victorianbigbattery.com.au/
U.S. Pat. No. 10,946,762
WO 2019/234248
WO 2021/074406
US 2020/0231057
EP 4002633
GB 2554343
EP 4071958
GB 2537944

1. A device for distributing power from an electrical power generator to batteries, the device comprising:
a power input for electrically connecting to the power generator,
a first power connector for electrically connecting to a storage battery, and a releasable second power connector for electrically connecting to a mobile battery,
a power distributor in electrical communication with the power input and the first and second power connectors, wherein the power distributor is for distributing power from the power input to each of the power connectors, and
a controller in communication with the power distributor, wherein the controller is for determining the distribution of power in response to data receivable on the power input from the power generator, and for signalling to the power distributor to provide the determined distribution of power.

2. The device of claim 1, further comprising:
a power output for electrically connecting to an electricity grid,
wherein the power distributor is in electrical communication with the power output, and the power distributor is for distributing power from the power input to each of the power connectors and the power output,
wherein the controller is for determining the distribution of power in response to data receivable on the power output to the electricity grid.

3. The device of claim 2,
(i) further comprising a demand determination engine in communication with the controller and the power output, wherein the demand determination engine is for determining the power demand of the electricity grid and for sending data on the power demand to the controller; and/or
(ii) wherein the power distributor is for distributing power from the storage battery to the electricity grid through the power output; and/or
(iii) wherein the power distributor comprises a switch, for switching electrical distribution between the power connectors and the power outputs.

4.-6. (canceled)

7. The device of claim 1, wherein the controller is for determining the distribution of power in response to data receivable on the storage battery and/or the mobile battery.

8. The device of claim 7, further comprising a state of charge determination engine in communication with the controller and one or more of the power connectors, wherein the state of charge determination engine is for determining the state of charge of the storage battery and/or the mobile battery and for sending data on the state of charge to the controller.

9. The device of claim 1, wherein the power input is for receiving 100 kW or more from the power generator.

10. (canceled)

11. A system for distributing power from an electrical power generator to grid scale batteries, the system comprising
the device of claim 1,
a storage battery electrically connected to the first power connector, and
a mobile battery releasably electrically connected to the releasable second power connector.

12. The system of claim 11, wherein:
(i) the total discharge capacity of the mobile battery is less than the total discharge capacity of the storage battery, and/or
(ii) the maximum operable charge rate of the mobile battery is more than the maximum operable charge rate of the storage battery.

13. (canceled)

14. The system of claim 11, wherein the controller is in communication with the mobile battery and the controller is for signalling to the mobile battery to disconnect from or connect to the releasable second power connector in response to data on the mobile battery,

15. The system of claim 11, wherein the controller is in communication with the mobile battery and the controller is for signalling to the mobile battery to disconnect from or connect to a releasable third power connector at a different location to the power generator, wherein the third power connector is in electrical communication with an electricity grid or a third storage battery.

16. The system of claim 11, wherein the system includes two or more mobile batteries, releasably electrically connected to the releasable second power connector.

17. A method for controlling power distribution from a power generator to batteries, using a system comprising:
a power input electrically connected to the power generator,
a first power connector electrically connecting to a storage battery, and a releasable second power connector electrically connecting to a mobile battery,
a power distributor in electrical communication with the power input and the power connectors, wherein the power distributor is for distribution of power between each of the power input and the power connectors, and
a controller in communication with the power distributor, the method comprising the steps of:
determining the power input of the power generator and sending data on the power input to the controller,
the controller determining a distribution of power in response to the power input data, and
signalling from the controller to the power distributor to provide the determined distribution of power.

18. The method of claim 17, wherein the system further comprises a power output electrically connecting to an electricity grid, wherein the power distributor is in electrical communication with the power output, and the power distributor is for distributing power from the power input to each of the power connectors and the power output, and for distributing power from the first power connector to the power output, the method further comprising the steps of:
determining the power demand of the electricity grid and sending data on the power demand to the controller, and
the controller determining a distribution of power in response to power input data and power demand data.

19. The method of claim 18, wherein determining the distribution of power comprises comparing data on the power input from the power generator against data on the power demand of the electricity grid, and
when the power input is less than the power demand the controller distributes the power input to the electricity grid, or
when the power input is more than the power demand the controller distributes the power input to the storage battery and/or the mobile battery.

20. The method of claim 19, wherein when the power input is less than the power demand the controller distributes power from the storage battery to the electricity grid.

21. The method of claim 17, wherein
the controller is in communication with the storage battery and/or the mobile battery, and the method comprises:
determining data on the storage battery and/or the mobile battery, and sending data on the storage battery and/or the mobile battery to the controller,
the controller determining a distribution of power in response to the data on the storage battery and/or the mobile battery.

22. The method of claim 21,
(i) wherein determining the distribution of power comprises comparing the power input data to data on the maximum charging power of the storage battery, and
when the power input is less than the maximum charging power of the storage battery the controller distributes the power input to the storage battery, or
when the power input is more than the maximum charging power of the storage battery the controller distributes the power input to the storage battery and the mobile battery; and/or
(ii) wherein determining the distribution of power comprises comparing data on the state of charge of the storage battery against a maximum state of charge value, and
when the state of charge of the storage battery is less than the maximum state of charge value, the controller distributes power from the power input to the storage battery, or
when the state of charge of the storage battery is the maximum state of charge value or more, the controller distributes power from the power input to the mobile battery,
wherein the maximum state of charge value is 80%.

23. (canceled)

24. The method of claim 17, wherein the controller is in communication with the mobile battery and the controller signals to the mobile battery to disconnect from or connect to a releasable third power connector at a different location to the power generator, wherein the third power connector is in electrical communication with an electricity grid or a third storage battery, and the mobile battery transfers power to the third power connector.

25. (canceled)

26. The device of claim 1, wherein the storage battery is stationary and co-located with the power generator.

27. The device of claim 1, wherein the mobile battery is for transporting power from the power generator to a different location for discharging to a releasable third power connector.
